(19) United States
(12) Patent Application Publication
(10) Pub. No.: US 2007/0279015 A1
(43) Pub. Date: Dec. 6, 2007

(54) Integrated power factor correction capacitance unit

(76) Inventors: Francis X. Livingston, Pittsburgh, PA (US); Peter Morgan, Cranberry Township, PA (US); Bernard J. Schaltenbrand, Glenshaw, PA (US)

Correspondence Address: Barry I. Friedman, Esq.;Metz Lewis LLC, 18th Floor, 11 Stanwix Street, Pittsburgh, PA, 15222, US

(21) Appl. No.: 11/446,608

(22) Filed: Jun. 5, 2006

(51) Int. Cl. G05F 1/70

(52) U.S. Cl. 323/209

(57) ABSTRACT

An integrated power factor correction unit incorporates presized, preselected components within a housing structure. The integrated unit is intended to be selected and preassembled according to certain known criteria of the anticipated load and applied as a unit. The unit is also designed to mate easily to the load, both electrically and physically. The unit is further designed to occupy a minimum amount of space for ease of mounting near the load. The unit comprises at least one capacitor and a contactor. A fuse is optional. The unit may be manually or automatically engaged and remotely monitored for status.

### BACKGROUND OF THE INVENTION

1. Field of the Invention

This invention relates to power factor correction of inductive loads utilizing capacitance. More specifically, the invention is directed to an integrated power factor correction unit which contains pre-sized and pre-selected capacitors and adjunct components adapted for a specific load application.

2. Description of the Prior Art

Commercial and industrial power consumers typically seek to control power factor deviations in order to achieve more efficient utilization of purchased electrical energy. Power factor is a measure of the effective conversion of current into work output and is calculated as the ratio between the actual load power and the apparent load power. In any supply and distribution system, losses will occur as part of the normal transmission of electrical power through the system. Under ideal circumstances, a power factor of 1.0 represents the most efficient utilization of the distributed electrical energy as loss is accumulated in the supply system, the power factor drops below unity and is typically measured as a percentage of this ideal situation.

A relatively poor power factor is typically generated by a significant phase difference between the voltage waveform and the current waveform at the load. It is most typically observed in the presence of an inductive load, such as an induction motor, a power transformer, ballast and the like. These are typically found in great proliferation in industrial and commercial settings. Moreover, in many industrial settings, the utilization of multiple inductive motors which are continuously being cycled on and off, in a random pattern, may cause unique discontinuities or phase differences between the voltage and current at the various loads. As a matter of efficiency and cost-savings, the increase of power factor, as close as possible to unity, represents not only a more efficient utilization of power, but a reduced cost of operation. In many situations, electrical suppliers apply premium charges to users who exhibit poor power factor characteristics.

Power factor correction is typically in the form of the addition of capacitance to circuits which include induction motors. These are applied to reduce the inductive component of the current and, subsequently, reduce losses. In a typical motor load, a portion of the total current drawn by the motor represents the magnetizing current, which establishes the flux in the magnetic field required for motor operation. The magnetizing current is necessary for the motor's operation, but does not contribute to the work output of the motor. In many cases, power factor correction is applied to reduce the effect of the magnetizing current of the motor.

Power factor correction capacitors are typically wired in parallel with the motor load at various points in the distribution system. In a situation such as that described above, with a variety of inductive motors or loads being switched on and off independently, it is desirable to apply the capacitance to the individual load. It is to be specifically noted that power factor correction must be specifically matched to the inductive load with which it is associated. In an ideal system, a motor is corrected when the inductive reactance equals the capacitive reactance at the line frequency. It is important to note that over or under correction of the load will result in deleterious performance and possible damage to the capacitors and motors. Over correction is identified as having the resonance frequency be less than the line frequency.

Each inductive load, especially electric motors, require a particularly sized power factor correction capacitor to be associated therewith, which must be specifically calculated for the load. While a helpful starting point may be found in standard look-up tables or other theoretical predictors of optimum capacitance, the better practice is to specifically match the capacitance to the measured characteristics of the particular motor design.

The prior art contains a wide variety of references, which identify power factor losses and corrective capacitance. Price, U.S. Pat. No. 5,075,815, issued Dec. 24, 1991, discloses a universal capacitor power factor correction, including three capacitors. The capacitors are placed within a housing and may be utilized in both one and three phase operation. The housing contains multiple sets of three capacitors having difference capacitance in the range of fifteen to sixty microfarads. In this way, the Price device may be utilized in a variety of applications requiring different capacitance without need for purchase of additional units of different size.

Marbury, et al., U.S. Pat. No. 2,264,994 discloses the use of a housing having a variety of unequal sized capacitors, which can be combined and recombined in order to provide different levels of capacitance for three-phase operation.

Taylor, U.S. Pat. No. 5,440,442, issued Aug. 8, 1995, discloses a power factor correction unit, which contain a variety of differently sized capacitors interconnected by a series of switches. The user may experimentally apply a variety of capacitors in different combinations in order to “dial in” experimentally an appropriate power factor correction.

The prior art also contains a variety of different power factor correction units, which are intended to incorporate integrated housing and flexible capacitance. Without specific reference to a particular United States Patent, it is also well-known in the art to provide a preset capacitor, or set of capacitors, which is matched to an appropriate load. The difficulty associated with assembling a power factor correction device as a whole not only includes the appropriate sizing of the included capacitance, but also the utilization and assembly of appropriate adjunct equipment in order to connect the capacitance to the load. At a minimum, a selectable contactor device, or switch, should be incorporated so that the capacitance may be removed from the load after the load has reached its optimum operating parameters and the need for power factor correction is reduced or eliminated. Additionally, appropriated fusing is appropriate for minimum standards of safety and protection of the other components in the electrical system.

Some of the prior art patents above include the adjunct components, such as contactors, but in many cases, it is left to the user to select the appropriate level of capacitance and assemble the accessory components in both an electrical circuit and physical location convenient for application to the load. In many cases, the expertise required to assemble and design such a device is beyond the capacity of the user and provides a substantial barrier to the application of effective power factor correction. In most situations, the contactor switch and fuses must be appropriately wired and sized so that the integrated unit may operate efficiently and safely.

What is lacking in the art, therefore, is an integrated power factor correction unit, which includes all of the desired components as well as appropriate capacitance, pre-sized and pre-selected, for a given inductive load. Such a unit is intended to be a bolt on solution for the user and is also intended to be compact and easily mounted within an appropriate physical proximity to the subject load.

### SUMMARY OF THE INVENTION

An integrated power factor correction unit is disclosed which incorporates presized, preselected components within a housing structure. The integrated unit is intended to be selected according to certain known criteria of the anticipated load and applied as a unit. The unit is also designed to mate easily to the load, both electrically and physically. The unit is further designed to occupy a minimum amount of space for ease of mounting near the load.

The unit is comprised primarily of a housing which supports at least one capacitor and a contactor for selective engagement of the capacitor into the load circuitry. The capacitor and contactor are electrically connected to the load and are engaged during the initial phase of load activation. The contactor may be manually or automatically engaged and may further contain sensors or other detectors to permit remote monitoring of the status of the contactor.

The unit is constructed from components which are preselected according to criteria which match the capacitive components to the ampacity or other known characteristics of the associated load. These criteria also assist in the selection of a contactor as well as optional fuses which are able to accept the given level of current. Wiring and/or buss bars are utilized to interconnect the various components and, given the known characteristics of the load and current within the unit, may be sized to precisely accommodate the load and current while minimizing space utilization. A housing surrounds and supports the components which is also preferably minimally sized.

These and other advantages and features of the present invention will be more fully understood with reference to the presently preferred embodiments thereof and to the appended drawings.

### BRIEF DESCRIPTION OF THE DRAWINGS

FIG. 1 is a diagrammatic representation of the integrated power factor correction module.

FIG. 2 is a schematic diagram of the embodiment depicted in FIG. 1.

FIG. 3 is a schematic diagram of a second embodiment of the integrated power factor correction module.

### DESCRIPTION OF THE PREFERRED EMBODIMENTS

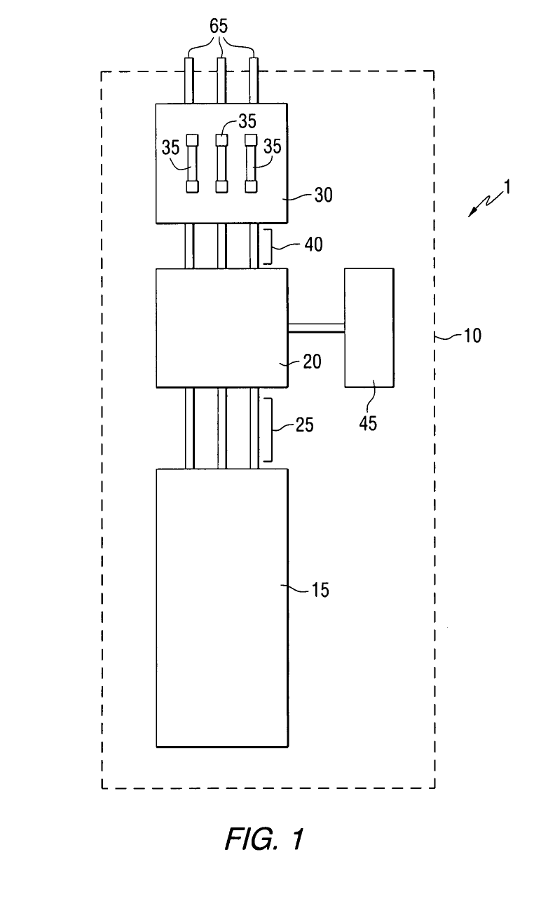

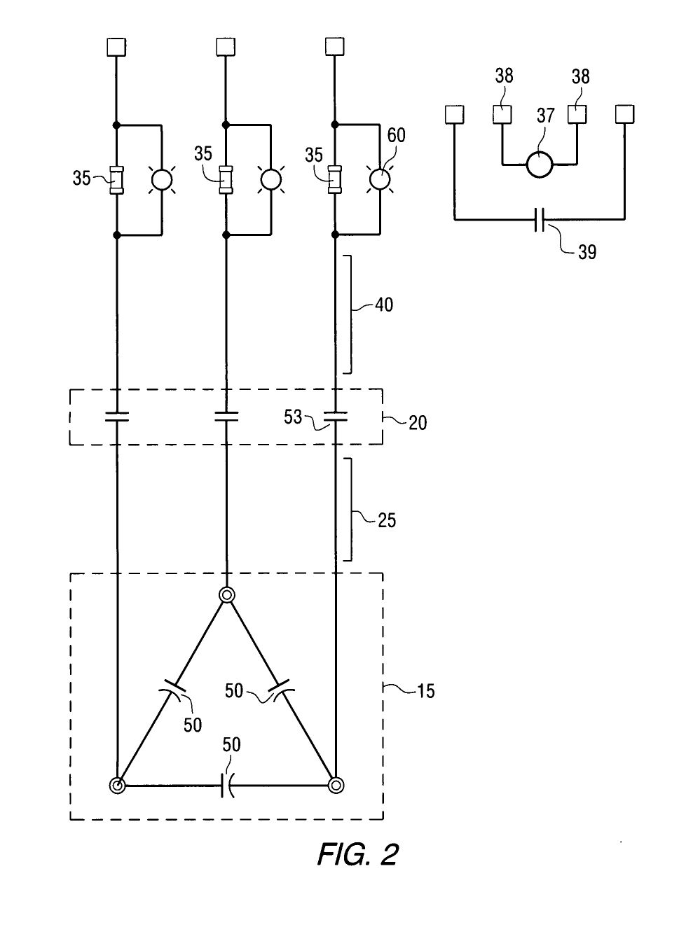

Referring to FIG. 1, an integrated power factor correction unit 1 includes an integrated housing 10, which is intended to completely enclose and support all of the interior components. It is specifically intended that the device be easily mounted and transported. It is also specifically intended that the housing be as compact as possible to facilitate mounting on or in close conjunction with the associated operational load while maintaining effective heat dissipation characteristics and other thermal performance properties. The device includes a capacitor unit 15, which may embody either a single capacitor unit or multiple capacitors, which are electronically interconnected to provide the appropriate capacitance as will be described with further reference to FIG. 2. The capacitors are preferably self-healing models, which provide some fault tolerance. The election of a single or multiple capacitor embodiment is primarily based upon cost considerations and the availability of off-the-shelf capacitors in the appropriate size. It is specifically intended that the capacitor be matched to the appropriate load and not oversized. The capacitors may be utilized in a multiple capacitor embodiment and in combination so that sizes not provided in a unitary off-the-shelf capacitor can be assembled through the combination of various components. It is specifically intended that the operational range of the device be between 10 and 200 KVar and will be provided in-both 480 and 600 volt embodiments. Examples of specific capacitor models, as manufactured by General Electric, Asea Brown Boveri and Ducati are GEM, LVNQ, and MODILO series.

Referring now to FIG. 2, capacitor unit 15 is shown having three capacitors 50 electronically interconnected in a multiple parallel configuration, as will be well-known in the art, it is to be specifically noted that the capacitors are not necessarily of equal size.

Referring now to FIGS. 1 and 2, contactor 20 is interconnected with capacitor unit 15 through capacitor contactor interconnect 25. Interconnect 25 may be a wire connection or a bussed connection, depending upon the size of the components, the load required and cost considerations. In the event that a wired embodiment is employed, the wires must be terminated in any conventional manner, including terminal blocks and studs. It is to be specifically noted that studs are preferable as being more physically robust connections. It is also to be noted that as physical and electrical size increases, that the buss embodiment is more preferable as terminal blocks do not provide the level of performance required. An additional consideration is minimization of the thermal properties of the buss or wire material and the operating load.

A buss embodiment also provides a more compact package and permits the sizing of housing 10 to be reduced, further increasing the utility of the device as a whole. Additionally, a buss embodiment provides better opportunity for cooling, which leads to reduced thermal breakdown over time. While the buss and wire embodiments may be comprised of a variety of conducting materials, copper is considered the most preferable.

A variety of contactor units may be employed, including the RSC series manufactured by Benshaw, Inc., and may also include an auxiliary contact as would be well-known in the prior art. An auxiliary contact provides a second set of switches, which close prior to the main contact switch 55 closing after a relatively short delay, typically on the order of eight milliseconds or less. Contact coil 37 is interconnected with switch 55 and, upon entering the energized state, closes the auxiliary contact switches which close the main contact switches 55. In an embodiment including an auxiliary contact switch, a high resistance wire is utilized to connect the main and auxiliary switching devices between main switches 55 and switch connectors 38. A second auxiliary contact 39 may also be provided, which is merely utilized to indicate the closed and open status of the main contact. Second auxiliary contact switch 39 is physically connected to the main contact switch 55 and is closed and opened simultaneously. In all auxiliary contact embodiments, the utilization of the auxiliary is primarily intended to reduce voltage spikes at the time of initial contact by allowing a certain amount of voltage to pass to the components prior to the main voltage surge. This is specifically intended to reduce wear and maintenance and prolong the life of the other components. It would be well known to those skilled in the art to preselect and presize any auxiliary contactors to provide a specific ramp up voltage pattern, which is adapted to match the performance characteristics of the integrated power factor correction unit 1.

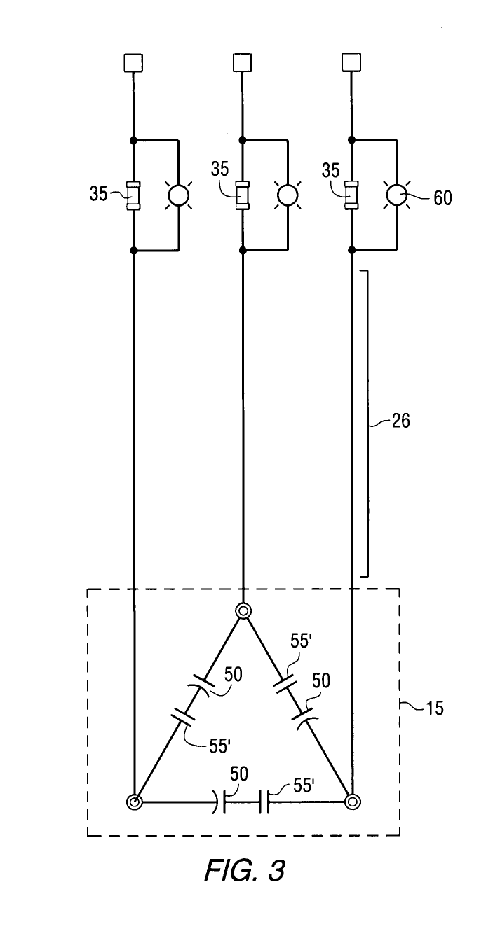

Referring now to FIG. 3, an alternative embodiment provides the electrical connection of the discrete main contact switches 55′ within the delta wiring configuration of the capacitors 50. It is to be specifically noted that the physical contactor 20 which contains main contact switches 55′ is still present as a physical device within the module, although not apparent in the schematic illustrated in FIG. 3. Interconnection 26 represents the electrical connection between the delta circuit and the fuses, but is not present as a discrete physical component. This is a popular technique for motor controls. It allows contactor 20 to be used in a higher rated system because the current inside the delta is 1/(sqrt 3) less than the line current outside the delta. This permits the use of a smaller contactor to switch the capacitor bank. For example: in the embodiment illustrated in FIG. 2, for a 5 KVar capacitor bank the current through the contactor would be 6 amps. But the current through each leg of the capacitor which is connected in delta would be 3.46 amps. So the contactor in the FIG. 2 configuration would need to carry 6 amps the contactor inside the delta as shown in FIG. 3 would only need to carry 3.46 amps. There is no operational difference between the two embodiments.

A fuse block 30 is optionally provided in the preferred embodiment in order to provide a certain degree of short circuit and thermal overload protection of the capacitor components as well as the delivery of voltage to the load. Fuse block 30 is interconnected with contactor 20 through contactor fuse interconnect 40. Similar to interconnect 25, interconnect 40 may be wired or bussed according to the same criteria described earlier. Fuse block 25 includes any type of circuit interrupter, which may be either fuses or breakers 35, and which are considered to be interchangeable. Further reference in this description to fuses should be understood to include either fuses or breakers. Additionally, optional status light 60 may be provided to indicate to an outside observer or may be remounted remotely in order to indicate the status of the various associated circuits.

Integrated power factor correction unit 1 is interconnected with the appropriate load device through power factor correction unit interconnect 65, which in the embodiment shown in FIGS. 1 and 2, is provided for a three phase operation. As will be well known to those skilled in the art, the correction unit 1 is mounted in a conventional manner and is specifically intended to provide a minimum of installation, time and complexity.

A predominant characteristic of the integrated power factor correction unit 1 is that all of the internal components are presized and preselected to match the ampacity of the load so that the device is designed and applied to a specific rated load, relieving the user from both selecting and assembling the associated components based upon criteria established for the safe and efficient operation of the motor and other loads. Presizing and preselecting the load reduces size as well as cost and ensures appropriate performance and longevity. Additionally, the units may be certified in advance by any one of the appropriate agencies, such as Underwriters Laboratories, to provide assurances of safe operation. As referenced above, the appropriate presizing and preselection of the components is not a trivial exercise and is considered to be an important aspect of the design considerations. More specifically, for a single motor application, the capacitor selection criteria first includes the selection of the motor itself. The relevant aspects of the motor include the horsepower rating, voltage, the no-load current and the full load amperes or FLA. If no load current is not available, the FLA is multiplied by a factor of 0.3. Capacitor selection is based upon the KVar ampacity of the load, with the 0.3*FLA value representing the maximum allowable value. Once the capacitor has been selected, the amperage draw determines the contactor size requirement. Each contactor has a specific operating ratings for switching capacitors. The wire size is calculated by multiplying the capacitor current by 1.35 and applying that value to the National Electric Code table of wire ampacity. Terminal block required size is determined the same way as the wire size. Buss bar sizing must also be sized for 1.35 times the capacitor current with the criteria being 1 square inch of copper cross sectional area for each 1000 A. Fuse size must be between 1.6 times the capacitor current and 2.5 times the motor FLA.

### EXAMPLE 1

### Load Motor: 25 Horsepower, 460V, 34 FLA

Calculation of maximum amperage=0.30*34=10.2 A

Selection of Contactor: Contactor with a capacitive current rating greater than the maximum Amperage dictates a Benshaw RSC-9 with rated capacitive current of 14 A.

Selection of Fuse: 2.5*10.2=25.5 A, which is rounded down to a standard value of 25 A. Fuses are typically sized between 1.5 and 2.5 times the maximum amps calculation.

Size of wiring: Wiring is sized by multiplying 1.33 times the maximum amperage and then applying that number to the National Electric Code wire ampacity table 310-16. Thus, the calculation is, for 75 degree C. copper column: 10.2*1.33=13.6 A. According to the table, #14AWG wire is rated at 20 A so #14 AWG wire would be used.

Size of buss bar: Bus bar cross sectional area (square inches) is a minimum of 1.33 times the maximum amperage divided by 1000. Thus, 10.2*1.33/1000=0.0136 sq. in. For practical purposes, 0.25″ wide×0.0625″ thick material (0.016 sq. in.) would be used.

A terminal block 45 interconnected with contactor 20 is also provided to permit both remote operation and monitoring of the unit. Terminal block 45 is intended to provide for selective engagement or disengagement of the integrated power factor correction unit 1 through the enablement or disablement of the contact coil 37 by remote electronic signal well known to those skilled in the art.

While a present preferred embodiment of the invention is described, it is to be distinctly understood that the invention is not limited thereto but may be otherwise embodied and practiced within the scope of the following claims.

What is claimed is:

1. An integrated power factor correction unit for electronic association with a load having identified load criteria, comprising:
a housing;
a capacitive unit capable of storing an electric charge which is sized according to said load criteria, said capacitive unit being mounted within said housing;
a contactor switch electrically connected to said capacitive unit which is also sized according to said load criteria, said contactor switch also being mounted within said housing; and
at least one interconnector which provides said electrical connection between said capacitive unit and said contactor switch which is also sized according to said load criteria, said at least one interconnector also being mounted within said housing.

2. An integrated power factor correction unit as described in claim 1, further comprising at least one circuit interrupter which is electrically connected between said contactor switch and the load, said circuit interrupter also being mounted within said housing.

3. An integrated power factor correction unit as described in claim 2, wherein said circuit interrupter is one of at least one fuse and at least one circuit breaker.

4. An integrated power factor correction unit as described in claim 2, wherein said circuit interrupter is sized between 1.6 times the capacitor current and 2.5 times the motor FLA.

5. An integrated power factor correction unit as described in claim 1, wherein said housing is minimally sized while retaining appropriate heat dissipation properties.

6. An integrated power factor correction unit as described in claim 1, further comprising interconnection means between said contactor switch and said load.

7. An integrated power factor correction unit as described in claim 1, wherein the operational range of the unit is between 10 and 200 KVar.

8. An integrated power factor correction unit as described in claim 1, wherein said capacitive unit further comprises a single capacitor.

9. An integrated power factor correction unit as described in claim 1, wherein said capacitive unit further comprises a plurality of capacitors.

10. An integrated power factor correction unit as described in claim 1, wherein said load criteria includes at least one of: horsepower rating, voltage, the no-load current and the full load amperes.

11. An integrated power factor correction unit as described in claim 1, wherein said capacitive unit is minimally sized by multiplying the full load amperes of the load by a factor of 0.3.

12. An integrated power factor correction unit as described in claim 1, wherein said capacitive unit further comprises a plurality of capacitors connected in a multiple parallel configuration.

13. An integrated power factor correction unit as described in claim 1, wherein said at least one interconnector is further comprised of one of wire or a buss connection.

14. An integrated power factor correction unit as described in claim 13, wherein said interconnector is minimally sized by multiplying the capacitor current by 1.35 and applying that value to the National Electric Code table of wire ampacity.

15. An integrated power factor correction unit as described in claim 1, wherein said contactor switch is further comprised of a main contactor and an auxiliary contactor.

16. An integrated power factor correction unit as described in claim 1, further comprising a terminal interconnection which is electrically connected to said contactor and which is also mounted within said housing.

17. An integrated power factor correction unit as described in claim 16, wherein said terminal interconnection is provided for remote operation of said unit.

18. An integrated power factor correction unit as described in claim 1, further comprising a sensor for detection of the operational status of the unit.
